(19) United States
(12) Patent Application Publication
(10) Pub. No.: US 2014/0258903 A1
(43) Pub. Date: Sep. 11, 2014

(54) DISPLAY DEVICE AND DISPLAY METHOD FOR ENHANCING VISIBILITY

(71) Applicant: Sharp Kabushiki Kaisha, Osaka-shi, Osaka (JP)

(72) Inventors: Masayoshi Kanbara, Osaka-shi (JP); Megumi Itoh, Osaka-shi (JP); Masaki Tabata, Osaka-shi (JP); Shuhei Nakamoto, Osaka-shi (JP); Kentaro Uekane, Osaka-shi (JP)

(21) Appl. No.: 14/347,670

(22) PCT Filed: Sep. 26, 2012
(86) PCT No.: PCT/JP2012/074614

§ 371 Date: May 21, 2014

(30) Foreign Application Priority Data
Sep. 28, 2011 (JP) 2011-212670

(51) Int. Cl. G06F 3/0481; G06F 3/0488; G06F 3/0486

(52) U.S. Cl. CPC G06F 3/04817; G06F 3/0486; G06F 3/0488
USPC 715/765

(57) ABSTRACT

Visibility of an icon which is on the edge of a display area which is hidden by a finger is enhanced.

When a distance between the movement base position and the movement destination position of the icon is short, the icon is displayed to be moved via a detour.

### TECHNICAL FIELD

The present invention relates to a display device and a display method for enhancing the visibility of a screen display.

### BACKGROUND ART

A device or the like in which an icon is moved by dragging the icon displayed on a touch panel with a finger or the like has been known. In such device, various functions can be performed by moving the icon to a specific area or by moving the icon on the top of another icon.

For example, a technique of transmitting individual card data to other device by dragging an individual card screen to an area in an edge is disclosed in PTL 1.

Further, a technique in which if an icon is dragged toward a transmission destination device, after the icon is moved in the direction, an animation in which the icon goes to the outside of the display area is displayed in order that the data transmission is easily recognized is disclosed in PTL 2.

### CITATION LIST

### Patent Literature

PTL 1: Japanese Unexamined Patent Application Publication No. 2003-152615

PTL 2: Japanese Unexamined Patent Application Publication No. 2003-32507

### SUMMARY OF INVENTION

### Technical Problem

However, if the animation disclosed in PTL 2 is performed with the apparatus disclosed in PTL 1, the icon is located near the edge of an area when the drag has ended, and thus even if an animation showing the icon being moved from the area to the outside of the display area is performed, the movement distance or display time of the icon becomes short. Therefore, it is difficult for the user to know what has happened.

Further, in addition to the case in which the icon is in the edge, even in the case in which the icon moves in the display area, when the movement distance of the icon is short, similarly, the change is not easily seen. Further, when the drag is ended, the finger is close to the icon, and thus the icon is hidden by the finger and it is more difficult to see the change.

A problem is that the status change such as the movement of the icon is not easily recognized, since the icon is in the edge or under a pointer such as a finger. An object of the present invention is to solve the problem.

### Solution to Problem

In order to solve the problem described above, there is provided a first display device according to the present invention including a display unit; and a display control unit that displays an icon so that the icon displayed on the display unit is moved from a first position to a second position, in which when a distance between the first position and the second position is shorter than a predetermined value, the icon is displayed to be moved from the first position to the second position via a detour.

According to this, when the movement distance of the icon is short, if the movement of the icon can be displayed for a long time, how the icon is moved as a result can be more easily shown to the user so as to be easily recognized.

In addition to the first configuration of the present invention, there is provided a second display device according to the present invention in which the first position is an edge of a main area in which the icon is displayed before operation, and the second position is a position where the icon has disappeared from the display unit.

According to this, when the icon is moved to disappear from the edge of the display device, the indication of the movement can be shown to the user so as to be more easily recognized.

In addition to the second configuration of the present invention, there is provided a third display device according to the present invention in which when the icon is moved from the first position to the second position, the display control unit displays the main area to be moved or reduced in size in a direction from the second position to the first position and sets an area generated outside the main area which is generated by the movement or the size reduction to be a virtual external area.

According to this, the indication in which the icon goes to the outside of the display device can be virtually expressed, and the indication of the movement can be shown to the user so as to be more easily recognized.

In addition to the second configuration of the present invention, there is provided a fourth display device according to the present invention in which when the icon is dragged, the display control unit displays the main area to be moved or reduced in size in a direction opposite to that of the drag, and sets an area generated outside the main area to be a virtual external area.

According to this, it is easily recognized to which position the icon is to be dragged so that a function such as transmission is performed, when the indication in which the icon goes to the outside of the display device can be virtually expressed.

In addition to the fourth configuration of the present invention, there is provided a fifth display device according to the present invention in which the display control unit divides the virtual external area into a plurality of areas and changes an operation in accordance with where in the virtual external area the icon is dropped.

According to this, if there are a plurality of choices, for example, in a case in which there are a plurality of data transmission destinations, or the like, the selection and the execution function (transmission) can be performed by one operation.

In addition to the fourth or fifth configuration of the present invention, there is provided a sixth display device according to the present invention in which the display control unit performs control so that if a plurality of icons are dropped in the first position, the icons are displayed one by one as moving outside the display area of the display device.

According to this, the information on which and how many icons are transmitted can be shown to the user so as to be more easily recognized.

In addition to any one of the fourth to sixth configurations of the present invention, there is provided a seventh display device according to the present invention in which the display control unit reduces the icon in accordance with the dragging of the icon when the icon is larger than a predetermined value.

According to this, even if the icon is large, the indication in which the icon is moved through the virtual external area outside of the display area can be shown to the user so as to be more easily recognized.

In addition to any one of the third to seventh configurations of the present invention, there is provided an eighth display device according to the present invention in which the display control unit performs a virtual frame display in which a frame portion of the display device is virtually displayed between the virtual external area and the main area.

According to this, that the main area is an area in which the display device is virtually expressed can be shown to the user so as to be more easily recognized.

In addition to the eighth configuration of the present invention, there is provided a ninth display device according to the present invention in which the display control unit divides the virtual frame display into a plurality of areas, and changes an operation in accordance with which area from among the divided areas of the virtual frame display the icon passes through.

According to this, for example, even if there are a plurality of data transmission methods, it is possible to easily select which method is to be used.

In addition to any one of the first to ninth configurations of the present invention, there is provided a tenth display device according to the present invention in which the display control unit displays the icon so that the icon moves from the first position to the second position like a piece of paper.

According to this, the indication in which the icon is moved can be shown to the user so as to be more easily recognized.

In addition to any one of the first to tenth configurations of the present invention, there is provided an eleventh display device according to the present invention in which the display control unit considers a drag operation performed in another display device as a drag operation performed on an icon of the display device itself.

According to this, even in the display device that the user may not directly operate, the same operability can be realized by using the display device that can be directly operated.

A method according to the present invention includes a display control step of displaying an icon so that the icon displayed on the display unit is moved from a first position to a second position, in which when a distance between the first position and the second position is shorter than a predetermined value, the icon is displayed so as to be moved from the first position to the second position via a detour.

According to this, when the movement distance of the icon is short, the movement of the icon can be displayed for a long time, and how the icon is moved as a result can be more easily shown to the user so as to be easily recognized.

In addition, the “icon” according to the present invention is not limited to a reduced image indicating data or an application, but the image itself being reduced such as a thumbnail of the image or a software button (key) is included.

### Advantageous Effects of Invention

According to the present invention, when the icon is moved from the first position to the second position, if the distance between the first position and the second position is smaller than a predetermined value, the icon is displayed to be moved from the first position to the second position via a detour. Therefore, even when the icon goes from the edge to the outside of the display area or the icon is hidden by a finger or the like, the visibility of the indication in which the icon is moved can be enhanced.

### BRIEF DESCRIPTION OF DRAWINGS

FIG. 1 is a block diagram illustrating a function of a display device of the present invention.

FIG. 2 is a diagram schematically illustrating the display device of the present invention.

FIG. 3 is an explanatory diagram illustrating data transmission in the display device of the present invention.

FIG. 4 is an explanatory diagram illustrating an indication of data transmission in the display device described in Example 1 of the present invention.

FIG. 5 is an explanatory diagram illustrating an indication of data transmission in the display device described in Example 1 of the present invention.

FIG. 6 is a flow chart illustrating an operation of data transmission in the display device described in Example 1 of the present invention.

FIG. 7 is an explanatory diagram illustrating an indication of data removal in the display device described in Example 1 of the present invention.

FIG. 8 is an explanatory diagram illustrating an indication (display as if flying) of data transmission in the display device described in Example 1 of the present invention.

FIG. 9 is an explanatory diagram illustrating an indication (display of a virtual external area) of data transmission in the display device described in Example 1 of the present invention.

FIG. 10 is an explanatory diagram illustrating an indication (display of a video from a camera on the virtual external area) of data transmission in the display device described in Example 1 of the present invention.

FIG. 11 is an explanatory diagram illustrating an indication (dropping on the virtual external area) of data transmission in a display device described in Example 2 of the present invention.

FIG. 12 is a flow chart illustrating an operation (dropping on the virtual external area) of data transmission in the display device described in Example 2 of the present invention.

FIG. 13 is an explanatory diagram illustrating an indication (dividing the virtual external area) of data transmission in the display device described in Example 2 of the present invention.

FIG. 14 is an explanatory diagram illustrating an indication (dividing the virtual frame display) of data transmission in the display device described in Example 2 of the present invention.

FIG. 15 is an explanatory diagram illustrating an indication (a plurality of times of transmission) of data transmission in the display device described in Example 2 of the present invention.

FIG. 16 is an explanatory diagram illustrating an indication (transmission of huge icon) of data transmission in the display device described in Example 2 of the present invention.

FIG. 17 is an explanatory diagram illustrating an indication (reduction of entire area) of data transmission in the display device described in Example 2 of the present invention.

FIG. 18 is an explanatory diagram illustrating an indication (receiving operation) of data transmission in a display device described in Example 3 of the present invention.

FIG. 19 is an explanatory diagram illustrating an indication (receiving operation) of data transmission in the display device described in Example 3 of the present invention.

FIG. 20 is an explanatory diagram illustrating an indication (receiving operation) of data transmission in the display device described in Example 3 of the present invention.

FIG. 21 is a sequence diagram illustrating an operation (receiving operation) of data transmission in the display device described in Example 3 of the present invention.

### DESCRIPTION OF EMBODIMENTS

### First Embodiment

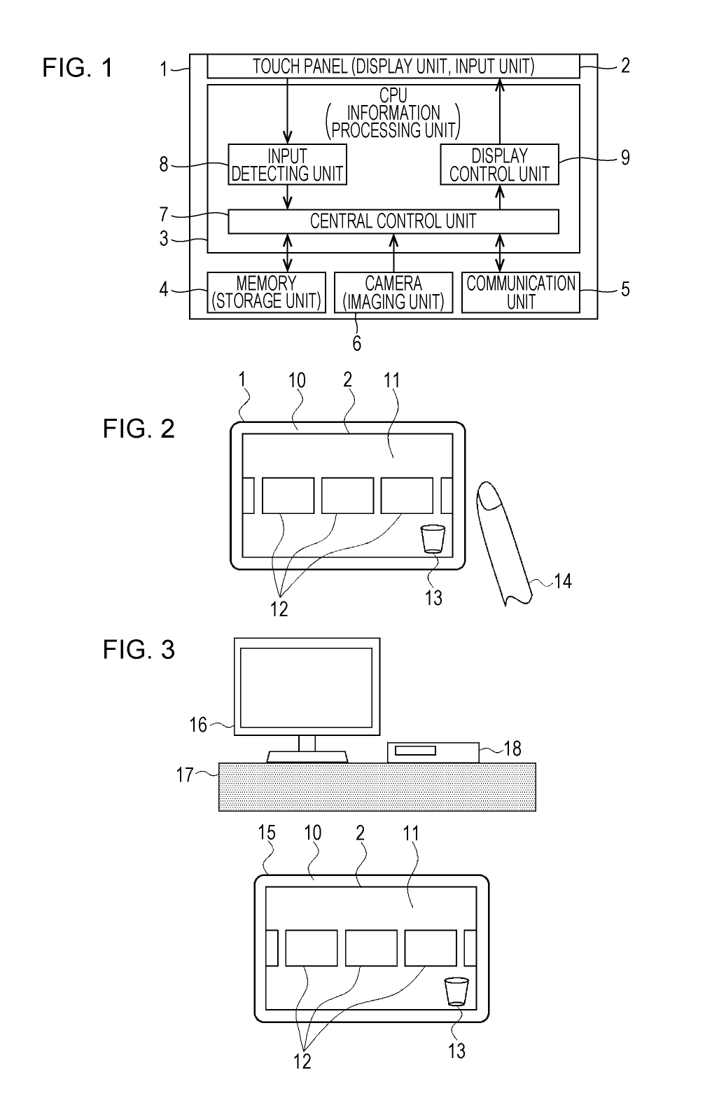

FIG. 1 is a block diagram illustrating a function of a display device 1 to which the present invention is applied. A touch panel 2 as a display unit and an input unit, a CPU 3 as an information processing unit, a memory 4 as a storage unit, and a communication unit 5 are included on the front surface portion of the display device 1. A camera 6 as an imaging unit is included on the rear surface portion. The memory 4 includes a ROM in which program data or the like are stored, and a RAM in which a process result is temporarily kept. Further, an HDD, a flash memory, or the like that reads and writes information may be included. Wi-Fi, Bluetooth (Registered Trademark), infrared rays, or the like are used as a communication method used by the communication unit 5, but the communication method is not limited thereto.

The CPU 3 includes a central control unit 7, the input detecting unit 8, and a display control unit 9. The input which is realized by touching the touch panel 2 is detected by the input detecting unit 8 of the CPU 3 and is sent to the central control unit 7 that performs a main process. The process result in the central control unit 7 is displayed on the touch panel 2 through the display control unit 9 that performs control relating to the display.

FIG. 2 is a diagram schematically illustrating an initial state (a state before operation) when the display device 1 is in an image viewing mode. A frame 10 and a touch panel 2 are provided on the front surface portion of the display device 1, and a plurality of icons 12 and a trash bin 13 for removing data are displayed on a main area 11 of the touch panel 2. Further, the main area 11 is a kind of so-called window which can be moved in all directions and which can be reduced in size, and is not necessarily identical to a display area of the touch panel 2. The entire row in which the icons 12 are in a line can be scrolled to the left or to the right, or the icons 12 can be dragged in the screen by tracing the row with a pointer 14 such as a finger.

FIG. 3 is an explanatory diagram illustrating an example in which a tablet 15 and a television 16 are used, as an example of performing data transmission between a plurality of display devices. The television 16 and a recorder 18 to be described below are placed on a stand 17, and data transmission is performed by operating the tablet 15 in a remote location. In addition, the television 16 and the tablet 15 are illustrated as being in the same room in FIG. 3, but the television 16 and the tablet 15 may be in different locations.

Further, the block diagram of the functions of the tablet 15 and the television 16 are the same as that illustrated in FIG. 1. However, a display device (the television 16 in the present example) with which an input operation may not be directly performed is not necessarily provided with the touch panel 2, the input detecting unit 8, or the camera 6.

If the operation of transmitting an image in the tablet 15 to the television 16 is performed, the transmission and reception of the image data is performed through the mutual communication unit 5, and the transmitted image is displayed on the television 16.

In the examples below, image data transmission between a combination of a tablet and a television is mainly described, but a smart phone or a personal computer may be included in the combination. Further, as described above, all display devices do not need to include an input detecting unit or a position input unit such as a touch panel and at least one apparatus may be included. Further, the at least one apparatus included may include a display unit that can display an image, for example, the apparatus may be a combined apparatus for transmitting and receiving data from a tablet to a video recorder.

Further, the data to be transmitted is not limited to an image, and the data may be a moving image or a document file.

### Example 1

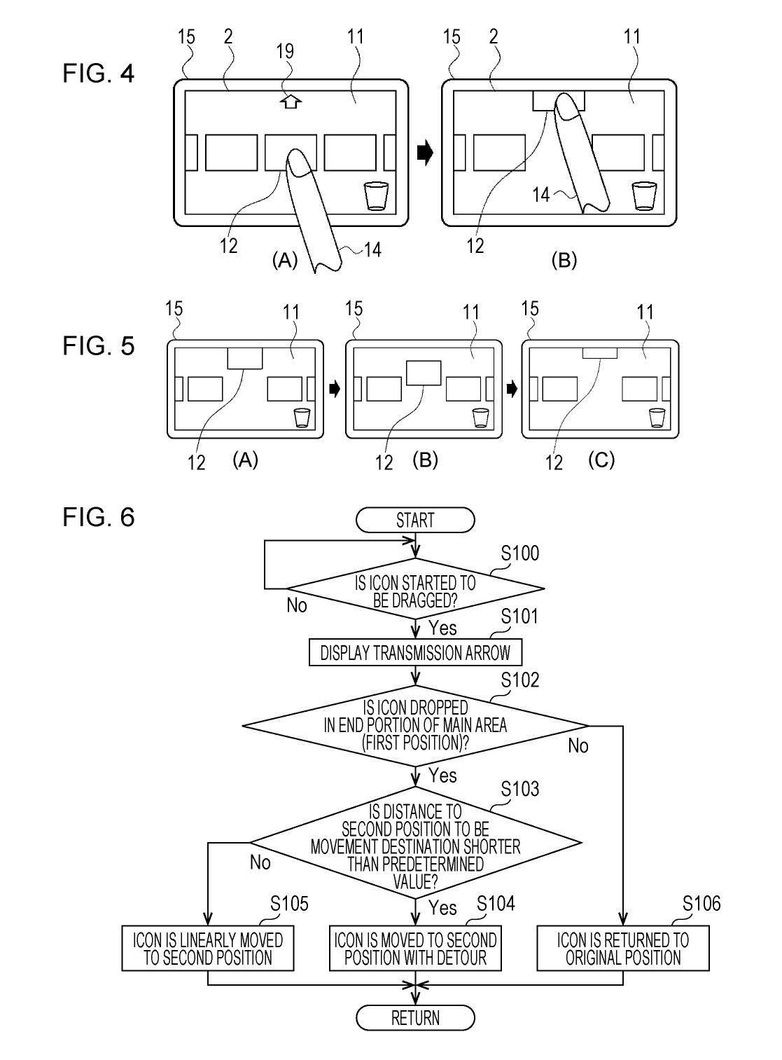

Subsequently, details of the operation at the time of transmitting and receiving an image are described with reference to the explanatory diagrams of FIGS. 4 to 5, and a flowchart of FIG. 6.

If the pointer 14 is in contact with one of the icons 12 on the touch panel 2 as illustrated in FIG. 4(A), and a drag is started (Step S100), a transmission arrow 19 showing a direction in which transmission is possible is displayed on an upper end of the touch panel 2 (Step S101).

Subsequently, as illustrated in FIG. 4(B), the icon 12 is dragged to an edge (first position) of the main area 11 in a direction towards a position where the transmission arrow 19 is displayed, and the pointer 14 is lifted from the touch panel 2 (hereinafter, referred to as “to drop”) (Yes in Step S102). In addition, the edge of the main area 11 described above is, for example, a position where a portion of the icon 12 is outside of the main area 11 (here, the main area 11 is identical to a display area of the touch panel 2).

In this manner, if the icon 12 is dropped at the edge of the main area 11, the display control unit 9 displays the icon 12 so as to be moved from the edge of the main area 11 to a position (second position) outside the touch panel 2.

In addition, the second position described above is, for example, a position (a position where the icon 12 is just out of sight from the display area of the touch panel 2) where the icon 12 disappears from the closest edge of the touch panel 2. Even if the icon 12 is moved to a position greatly separated from an edge of the touch panel 2 by an internal process, since the movement is not displayed on the touch panel 2 and does not affect to the visibility of the icon 12, even in such a case, it seems that the icon 12 is moved to a position outside the display area of the touch panel 2 at which it may not be seen.

The control of the display which is the movement of the icon is performed by the display control unit 9 as described below.

Here, if the distance between the first position and the second position is smaller than a predetermined value (for example, the height of the icon 12) in Step S103, the icon 12 is moved so as to be moved away from the second position and then the icon 12 is moved to the second position outside of the screen as illustrated in FIGS. 5(A) to 5(C) (Step S104). That is, the icon 12 is displayed so that the icon 12 is moved from the first position to the second position via a detour.

Here, the “detour” is not limited to a case where the icon is moved so as to be moved away once as in the example described above, but widely includes cases other than the case where the rectilinear movement is performed over a minimum distance, such as a case of movement along an arc-shaped path and a case of movement along a zigzag path. However, if the icon is dropped at the edge as described above in order to display the icon on the screen for a long time, it is particularly effective to move the icon so as to be moved away once. The description of the detour is the same in the following.

In addition, if the distance between the first position and the second position is larger than a predetermined value in Step S103, the icon 12 is linearly moved to the second position as in Step S105.

Further, if the icon 12 is dropped at a position other than the edge of the main area 11 in Step S102, the icon 12 returns back to the original position (Step S106).

As described above, since the movement of the icon 12 can be displayed for a long time in the present invention, an indication that the icon 12 moves from the edge of the screen to the outside of the screen of the tablet 15 can be shown in such a manner as to be easily recognizable by the user.

In addition, in Step S101, the transmission arrow 19 is displayed at the upper edge of the touch panel 2, but since it is considered that the user who has the tablet 15 is facing the transmission destination device in many cases, in the case in which a unit for detecting the position of the transmission destination device or the like is included or the like, the transmission arrow 19 may be displayed at an edge of the touch panel 2 other than the upper edge. Further, since function of the transmission arrow 19 is simply to make the dragging direction easily recognizable, it is not always necessary to display the transmission arrow 19.

Further, in Example 1, the icon 12 is displayed so as to move to the second position outside of the screen when the icon 12 is dropped at the edge of the main area. However, even if an intentional drop of the icon 12 by lifting the pointer 14 from the touch panel 2 is not performed, if a drag to the first position is performed, the icon 12 may be dropped, and displayed so as to move via a detour.

In this case, since the icon 12 when being dragged is in a state where it is hidden under the pointer 14, an effect of displaying an animation in which the icon 12 is moved to a position where the icon 12 is not hidden by the pointer 14 can be obtained by causing the icon 12 to be moved away from the second position once (for example, in a direction towards the center).

The aforementioned modification example relating to the transmission arrow and the drag is similar to Examples 2 and 3 described below.

In the example above, it is described that the icon 12 is moved to the outside of the display area of the tablet 15, but it is also described below that the icon 12 is moved in the main area 11 of the tablet 15 in the same manner.

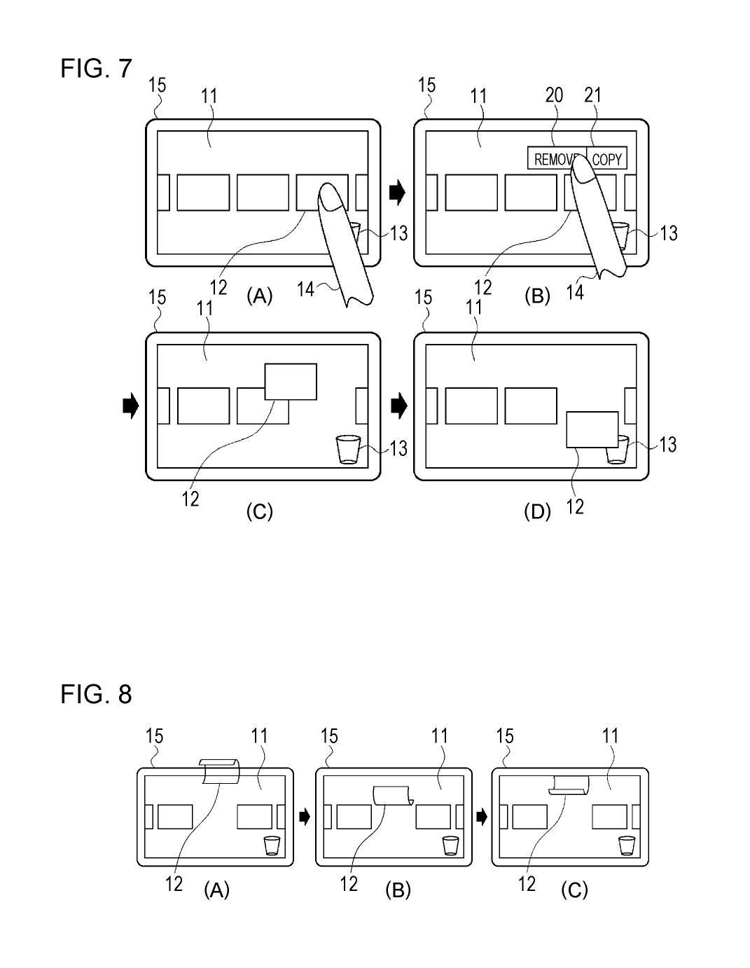

FIG. 7 is a diagram illustrating an example of an operation when the icon 12 is moved to a display area of the tablet 15. In FIG. 7(A), if an operation of a long-press on the icon 12 or the like is performed, a remove button 20 and a copy button 21 are presented as illustrated in FIG. 7(B).

Here, if the remove button 20 is pressed, an animation in which the icon 12 is moved to the trash bin 13 is performed. However, in FIG. 7(B), since the distance between the position (first position) of the icon 12 before the movement of the icon 12 and the position (second position) of the trash bin 13 is smaller than a predetermined value (for example, the height of the icon 12), the icon 12 is moved to the trash bin 13 via a detour as illustrated in FIGS. 7(C) and 7(D).

In addition, the icon 12 may be displayed in such a manner as to be gradually made smaller in accordance with the movement distance and the icon 12 shown as being sucked into the trash bin 13.

Further, if the copy button 21 is pressed, the same movement animation may be displayed according to a distance from a position (first position) of an icon of a copy source to a position (second position) of a copy destination.

According to this, when a rectilinear distance between the movement destination and the movement source of the icon 12 is short, the movement of the icon 12 can be shown to the user for a longer period of time. As a result, what has happened can be presented in an easily recognizable manner.

FIG. 8 is a diagram illustrating a modification example of the example illustrated in FIGS. 4 to 6. As illustrated in FIG. 4, when the icon 12 is dropped at the edge (first position) of the main area 11, if the distance between the icon 12 and the second position to the outside of the screen which is the movement destination is smaller than a predetermined value, the icon 12 is moved (in a direction toward the center) so as to be moved away from the second position, is displayed as a 3D image of a moving piece of paper in the main area 11 as illustrated in FIGS. 8(A) and 8(B), and is then moved to the second position outside of the screen as illustrated in FIG. 3(C) (moves via a detour).

According to this, the icon 12 can be displayed with a natural expression of returning back to the main area 11.

In addition, a portion of the icon 12 which is outside of the display extent of the main area 11 as illustrated in FIG. 8(A) is presented for easier understanding, but the portion is actually not displayed in practice.

Further, an expression as illustrated in FIG. 9 may be possible as a modification example of Example 1.

In the modification example, as illustrated in FIG. 4, when one of the icons 12 is dropped on the edge of the main area 11, if the distance between the icon 12 that has been dropped and the second position outside of the screen which is the movement destination is smaller than a predetermined value, the remaining icons 12 are moved in a direction (downward direction) so as to be moved away from the second position as illustrated in FIGS. 9(A) and 9(B), and the main area 11 can also be moved in a downward direction.

An area on the upper portion formed by moving the main area 11 in the downward direction becomes a virtual external area 22 virtually indicating that the area is an area outside the tablet 15, and a color, a pattern or the like is changed and displayed so that the area can be differentiated from the main area 11.

Further, a virtual frame display 23 in which the frame 10 of the tablet 15 is virtually expressed is displayed between the main area 11 and the virtual external area 22.

Subsequently, after the icon 12 reaches the vicinity of the center, if the movement direction is shifted so as to become an upward direction, display positions of the main area 11 and the virtual external area 22 are fixed, and only the icon 12 is moved in the upward direction, as illustrated in FIG. 9(C).

Subsequently, when the icon 12 moves to the second position outside of the screen of the tablet 15, if it is not displayed on the screen, the main area 11 returns back to the original position as illustrated in FIG. 9(D).

In addition, when the icon 12 is moved in the downward direction as illustrated in FIGS. 9(A) and 9(B), the amount of movement of the main area 11 in the downward direction is desirably greater than the amount of movement of the icon 12 in the downward direction at the same point in time. According to this, since the icon 12 is relatively moved in a direction (upward direction in the present example) toward the virtual external area 22 from the main area, the transmission of the data can be displayed in an easily recognizable manner.

Further, it is desirable that the width, the color, the pattern, or the like of the virtual frame display 23 be set to be the same as those of the actual frame 10, in order to give a strong impression that the tablet 15 is actually moved in the downward direction. Accordingly, if a physical button or a camera hole is present on a portion of the frame 10 of the tablet 15, it is more effective if display is performed so that the virtual frame display 23 has the same appearance.

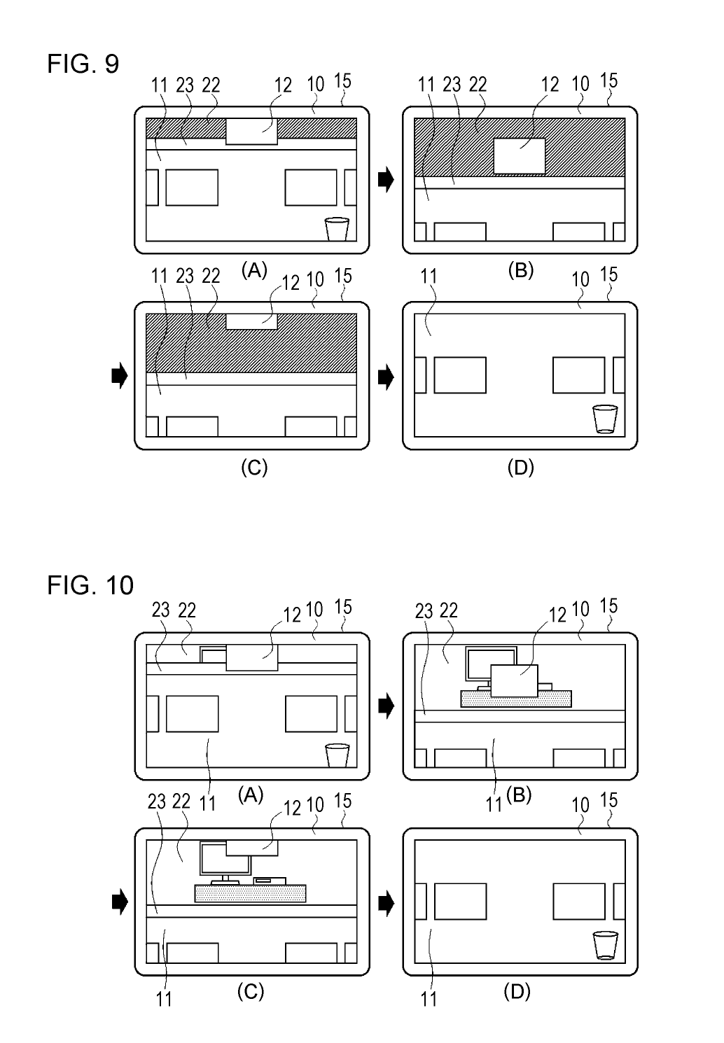

Further, if the tablet 15 includes the camera 6 as an imaging unit, a video captured by the camera 6 may be displayed on the virtual external area 22 as illustrated in FIG. 10.

In FIG. 10, the camera 6 mounted on the rear surface of the tablet 15 captures a real space including the television 16 and the captured video is displayed on the virtual external area 22, so that the icon 12 can be more realistically recognized by the user to be moved to the outside of the tablet 15.

In addition, the icon 12 is displayed to disappear in the upper end portion of the tablet in FIG. 10, but the icon 12 may be displayed so that the second position is placed in the virtual external area 22 and the icon 12 gradually becomes smaller as the icon 12 comes closer to the position of disappearing. In this manner, it is possible to give an impression that the icon 12 actually flies to the equipment to be the transmission destination.

In such cases, even if the distance between the first position and the second position is small, since an animation in which the icon 12 gradually becomes smaller can be observed by the user, it is possible to enhance the visibility without moving the icon 12 via a detour.

Further, if the user performs an operation of horizontally holding the tablet 15, a floor surface or the like is displayed on the virtual external area 22. However, even in such a case, the same effect can be obtained in that the icon 12 which is moved to the outside of the tablet 15 is shown.

### Example 2

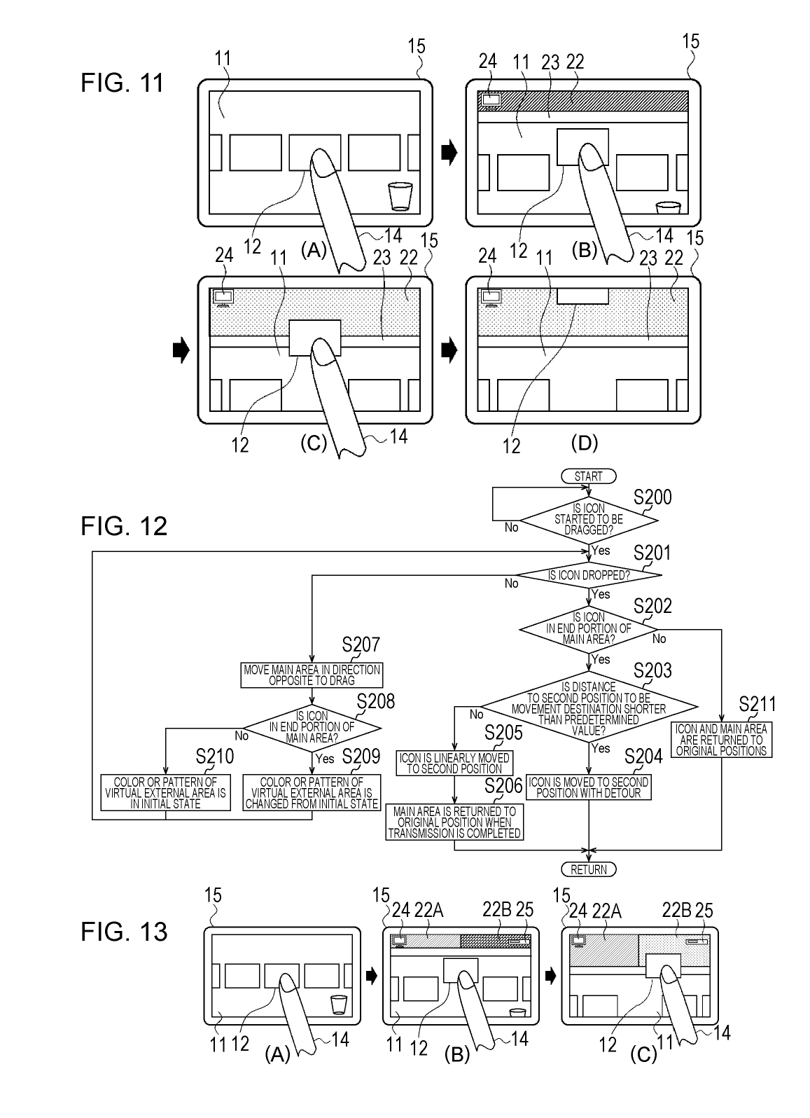

Subsequently, an example of changing a position of the main area 11 in association with the drag is described with reference to the explanatory diagram of FIG. 11 and the flowchart of FIG. 12.

If dragging the icon 12 in the upward direction is started as illustrated in FIG. 11(A) (Step S200), the main area 11 is moved in the downward direction opposite to the drag in response to the dragging distance as illustrated in FIG. 11(B) (Step S207), and the virtual external area 22 and the virtual frame display 23 appear in the upward direction. A television mark 24 indicating the equipment to be the transmission destination (the television 16 in the present example) is displayed in the virtual external area 22, so that it can be easily recognized what the equipment to be the transmission destination is.

Subsequently, in Step S208, the icon 12 is dragged to the first position (for example, a position where at least a portion of the icon 12 is in the outside of the main area 11) on the edge of the main area as illustrated in FIG. 11(C), and the color or the pattern of the virtual external area 22 is changed in order to show the state in which the transmission can be performed (Step S209).

Here, if the icon 12 is dropped (Yes in Step S201), the icon 12 is moved to the second position where the icon 12 has disappeared from the touch panel 2. However, since a distance between the first position and the second position is greater than a predetermined value (for example, the height of the icon 12) (No in Step S203), the icon 12 is displayed to be linearly moved to the second position as illustrated in FIG. 11(D) (Step S205). Then, if the icon 12 is not displayed on the tablet 15, the main area 11 returns back to the original position (Step S206).

In this manner, it can be easily recognized on which area the icon 12 is to be dropped so that the data of the icon 12 is transmitted. Further, since the icon 12 can be dragged to a position where the icon 12 necessarily comes to the outside of the main area 11 by moving the main area 11 in the downward direction without dragging a portion of the icon 12 to the edge of the touch panel 2 as described in Example 1, the distance between the first position (dropped position) and the edge of the touch panel 2 can be lengthened, and as a result, the movement animation of the icon 12 can be displayed for a longer period of time.

In addition, an example in which if the drag in the upward direction is performed, the main area 11 moves in the downward direction is described above, but for example if the drag in the right direction is performed, the main area 11 may be moved in the left direction opposite to the right direction.

Further, in the modification example of the present example, if a plurality of candidates are present as the equipment to be the transmission destination, the virtual external area 22 may be divided into a plurality of areas.

FIG. 13 is a diagram illustrating an example in which the recorder 18 as illustrated in FIG. 3 is present in addition to the television 16 as a candidate of the equipment to be the transmission destination. A change of the operation at the time of the transmission is described by using the same.

If there are a plurality of candidates of the equipment that perform the transmission, a virtual external area is divided into the virtual external area 22A that includes the television mark 24 and the virtual external area 22B that includes a recorder mark 25, as illustrated in FIG. 13(B) and displayed.

Here, if the icon 12 is dragged to a position where at least a portion of the icon 12 is included in the edge of the main area 11 and the virtual external area 22B, the color and the pattern of the virtual external area 22B are changed and if the icon 12 is dropped at the position, data indicated by the icon 12 is transmitted to the recorder 18.

According to this, even if there are a plurality of candidates of the equipment to be the transmission destination, the data can be intuitively transmitted to the desired equipment.

In addition, an example of changing an operation according to an area from among the divided areas of the virtual external area 22 to which the icon 12 is dropped is not limited to the configuration of changing the transmission destination as described above, but the example may be the configuration of changing a folder of the transmission destination, a transmission method (infrared rays, Wi-Fi, or the like), a Web site to be the transmission destination, or the like.

Further, the icon 12 may be overlapped with a plurality of virtual external areas, and transmission to an apparatus of which the overlapped area is greater may be performed or transmission to both apparatuses may be performed.

Further, as a method different from the method of dividing the virtual external area as described above, the virtual frame display 23 may be divided into areas and an operation may be changed according to an area from among the areas through which the icon 12 passes.

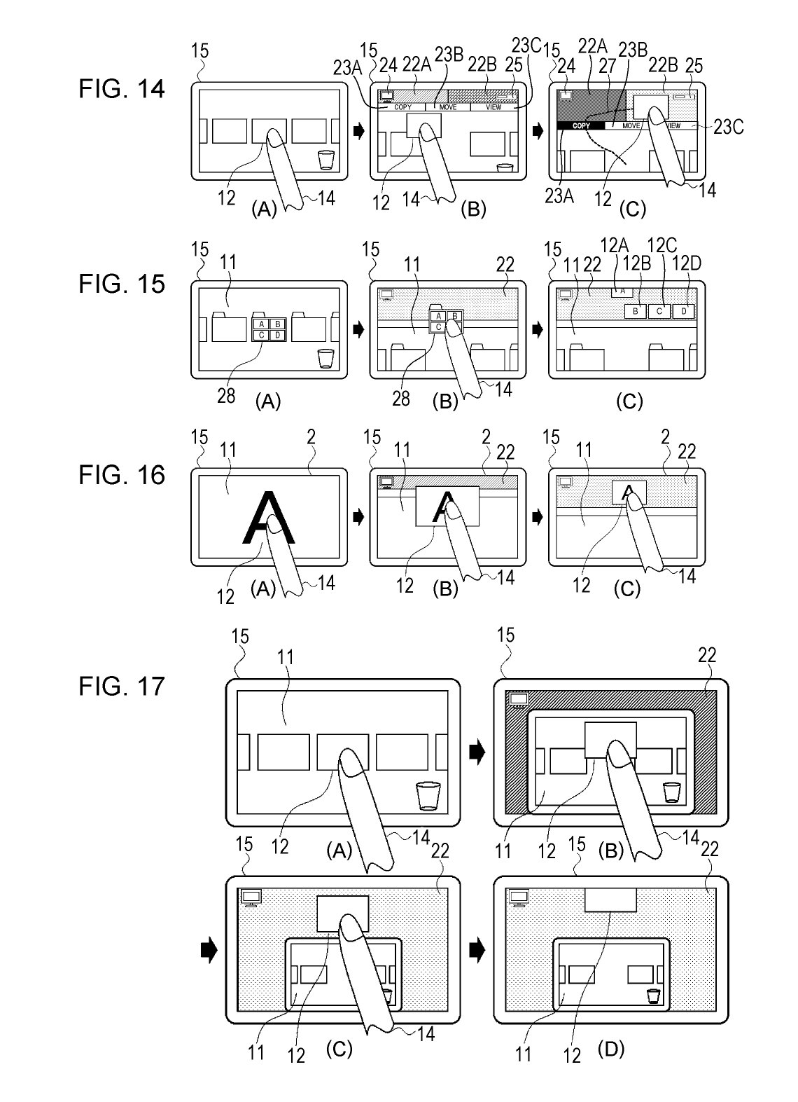

For example, if there are a plurality of candidates for the type of the transmission such as COPY (copying a file), MOVE (moving a file), VIEW (viewing a file without changing the file), a virtual frame display is divided into areas and the type of transmission may be determined according to an area from among the areas through which the icon 12 passes as illustrated in FIG. 14.

In this case, for example, when the icon 12 is moved in the upward direction as illustrated in FIG. 14(B), the virtual frame display is divided into the virtual frame displays 23A (COPY), 23B (MOVE), and 23C (VIEW).

Subsequently, if the icon 12 is moved so as to pass through the virtual frame display 23A as indicated by a track 27 of FIG. 14(C), the color of the virtual frame display 23A is changed.

Subsequently, if the icon 12 is dropped when the icon 12 is in the virtual external area 22B, the data indicated by the icon 12 is copied (COPY) to the recorder 18.

According to this, if there are two types of settings such as a plurality of transmission destinations and a plurality of transmission methods, an operation can be changed based on the two selected types of settings, by one dragging operation.

In addition, when the equipment to be the transmission destination passes through an area of the transmission method that does not correspond to the apparatus, the display of the equipment may disappear. For example, if the television 16 does not have a storage area and copying and moving operations may not performed, the virtual external area 22A and the television mark 24 may disappear when the icon 12 passes through the virtual frame display 23A and the virtual frame display 23B.

Subsequently, the transmission is performed for each folder including a plurality of items of image data as a modification example from Example 2.

When a folder 28 including a plurality of images is dropped on the edge of the main area 11 as illustrated in FIG. 15, the icons 12A to 12D for the images included in the folder 28 are displayed in the virtual external area 22, and the indication in which the images sequentially fly to the outside of the screen is displayed.

According to this, information on which and how many images are transmitted can be shown to the user so as to be easily recognized. In addition, though the icons are displayed in the folder 28 in FIGS. 15(A) and 15(B), it is not necessary for the content of the folder to be seen.

In the image view on the tablet 15, a case in which an image is displayed on the entire display area of the touch panel 2 as illustrated in FIG. 16(A) can be considered. In addition, the image that occupies most of the display area in this manner is not generally referred to as an “icon”, but the image is expressed as the icon 12 for simplicity.

If the size of the icon 12 is greater than the predetermined value (for example, half of the area of the touch panel 2), the icon 12 becomes smaller as the dragging distance in the upward direction is increased as illustrated in FIGS. 16(B) and 16(C), so that the changes in the main area 11 and the virtual external area 22 can be easily seen.

According to this, even in the case in which the icon 12 is large, the transmission of data can be performed with the same operability.

Further, as illustrated in FIGS. 17(B) and 17(C), as the icon 12 is dragged in the upward direction, the main area 11 may be displayed to be reduced in the downward direction which is opposite to the upward direction, so that an indication in which the icon 12 goes to the outside of the virtual external area 22 can be expressed to be more easily recognized. In addition, the “reduction in the downward direction” may refer to the movement of the center of the main area 11 in the downward direction while maintaining the aspect ratio of the main area 11 as illustrated in FIG. 17 or refer to the reduction only in the longitudinal direction (display in which the main area 11 is crushed).

In addition, in Example 2, it is described that the color of the virtual external area 22 is changed, or the television mark 24 is displayed when at least a portion of the icon 12 is included in the virtual external area 22. However, since the operations are provided in order to present the information on the transmission so as to be easily recognized by the user, the operations may not necessarily be performed in the present invention.

### Second Embodiment

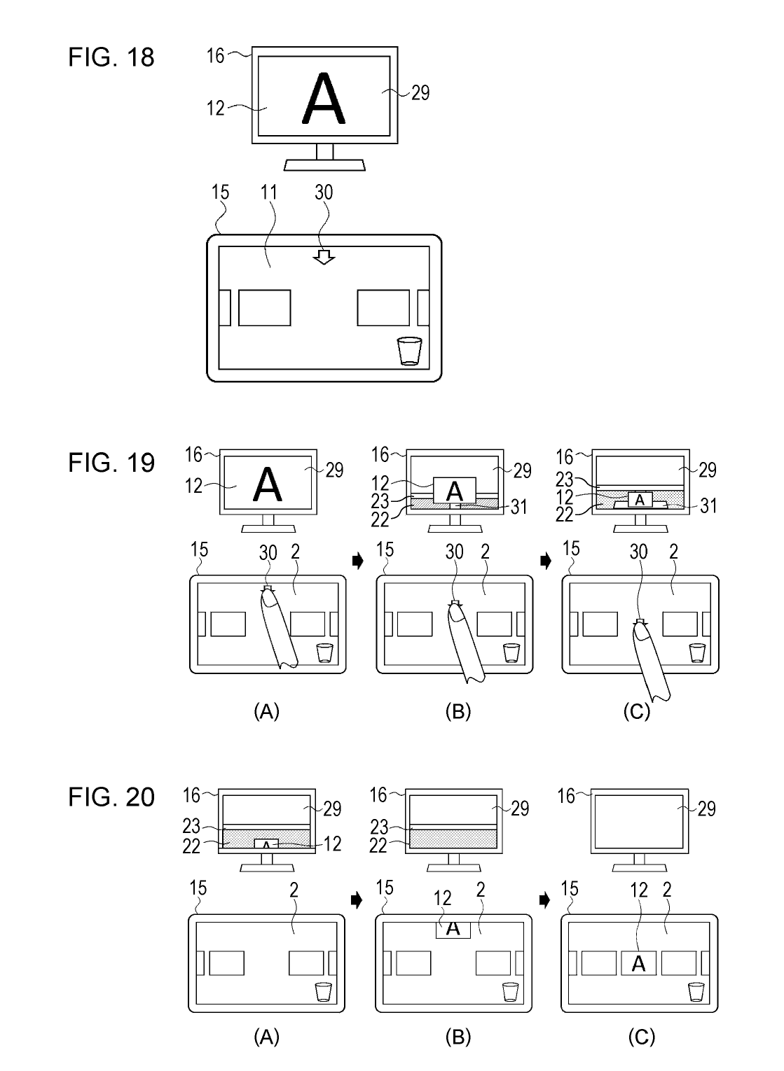

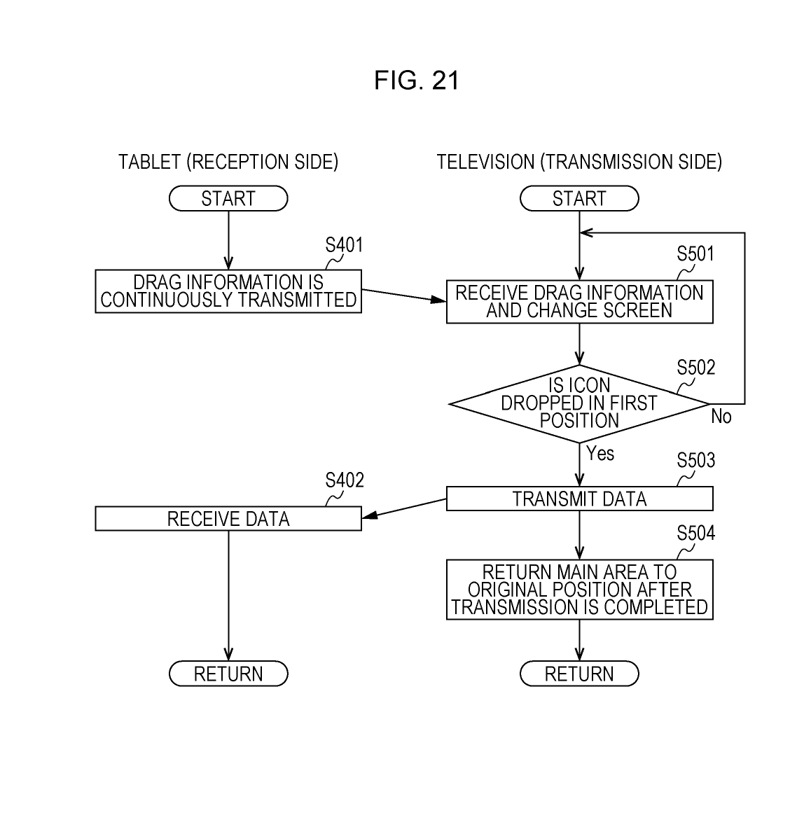

Subsequently, the transmission of data from the television 16 to the tablet 15 is described with reference to explanatory diagrams and a sequence diagram illustrated in FIGS. 18 to 21. In addition, if the television 16 includes the position input unit such as a touch panel, the operation is not limited to the following embodiment, but data transmission to the tablet 15 may be performed by directly operating the television 16 as described in the first embodiment.

### Example 3

FIG. 18 is a diagram illustrating a state after an image of “A” is transmitted from the tablet 15 to the television 16. As described above, the image occupying most of a main area 29 of the television 16 in this manner is not generally referred to as an “icon”, but the image is expressed as the icon 12 for simplicity.

At this point, a reception arrow 30 is displayed on the tablet 15, and indicates a direction in which the image can return to the tablet 15 (an image is transmitted from the television 16 to the tablet 15).

Here, as illustrated in FIGS. 19(A) to 19(C), if the reception arrow 30 on the tablet 15 is dragged to the lower side, the coordination data is transmitted to the television 16 (Step S401).

Subsequently, the icon 12 of the image of the television 16 is reduced and moved to the lower side according to the dragging distance based on the received coordination data in the television 16, as illustrated in FIGS. 19(B) and 19(C) (Step S501), and the virtual external area 22 appears and expands to the upper side.

In addition, in FIGS. 19(B) and 19(C), a virtual stand display 31 in which a stand portion of the television 16 is virtually expressed is also displayed together with the virtual frame display 23, but the display may be omitted if the visibility and the operability are disturbed.

Subsequently, if the icon 12 is dragged to the edge of the main area 29 of the television 16, the color and the pattern of the virtual external area 22 are changed. Here, if the pointer 14 is detached from the touch panel 2 (Yes in Step S502), the icon 12 is displayed to be moved from the television 16 to the tablet 15 as illustrated in FIG. 20, and the data indicated by the icon 12 is transmitted (Steps S503 and S402). Subsequently, if the transmission and the reception are completed, the main area 29 of the television 16 returns to the original position (Step S504).

In this manner, if one apparatus that performs the transmission and the reception includes the input unit such as the touch panel, the input information is transmitted to another apparatus so that both of the transmission and the reception by the operation method and the screen display in the same manner described in the first embodiment can be performed without directly operating the other apparatus. Further, even if the equipment to be the transmission destination is located at distance, the data transmission and reception can be performed just by operating the display device in hand.

In addition, when it is necessary to select an image to be received like the case in which the plurality of icons 12 are displayed on the television 16 or the like, the same screen as the television 16 is displayed on the tablet 15 in advance. If one icon is selected, a screen may be displayed as in the state of FIG. 19(A).

Further, the icon 12 is moved by dragging the reception arrow 30 in Example 3, but the icon 12 may be moved by dragging a location different from the reception arrow 30 in the downward direction.

Further, if the same image data is present in the tablet 15, the image data is not transmitted from the television 16 to the tablet 15, but the image displayed on the television 16 may be simply deleted. This corresponds to, for example, the case of dropping (returning the television 16 to the original display) the state in which the image transmitted in a VIEW operation (in which a file is viewed without changing the file) from the tablet 15 to the television 16 is viewed, or the like.

In the first and second embodiments of the present invention, the display device including a touch panel is described, but the visibility of the icon can be enhanced in the same manner even in the case in which a touch panel is not included and an icon is operated, for example, by a mouse.

### INDUSTRIAL APPLICABILITY

According to the present invention, it is possible to provide a display device in which the visibility can be enhanced at the time of moving the icon.

### REFERENCE SIGNS LIST

1 display device
2 TOUCH PANEL (DISPLAY UNIT/INPUT UNIT)
3 CPU (INFORMATION PROCESSING UNIT)
4 MEMORY (STORAGE UNIT)
5 COMMUNICATION UNIT
6 CAMERA (IMAGING UNIT)
7 CENTRAL CONTROL UNIT
8 INPUT DETECTING UNIT
9 DISPLAY CONTROL UNIT
10 FRAME
11 MAIN AREA
12 ICON
13 TRASH BIN
14 POINTER
15 TABLET
16 TELEVISION
17 STAND
18 RECORDER
19 TRANSMISSION ARROW
20 REMOVE BUTTON
21 COPY BUTTON
22 VIRTUAL EXTERNAL AREA
23 VIRTUAL FRAME DISPLAY
24 TELEVISION MARK
25 RECORDER MARK
27 TRACK
28 FOLDER
29 MAIN AREA
30 RECEPTION ARROW
31 VIRTUAL STAND DISPLAY

1. A display device comprising:
a display unit; and
a display control unit that displays an icon so that the icon displayed on the display unit is moved from a first position to a second position,
wherein when a distance between the first position and the second position is shorter than a predetermined value, the icon is displayed to be moved from the first position to the second position via a detour.

2. The display device according to claim 1,
wherein the first position is an edge of a main area in which the icon is displayed before operation, and the second position is a position where the icon has disappeared from the display unit.

3. The display device according to claim 2,
wherein, when the icon is moved from the first position to the second position, the display control unit displays the main area to be moved or reduced in size in a direction from the second position to the first position, and sets an area generated outside the main area which is generated by the movement or the size reduction to be a virtual external area.

4. The display device according to claim 2,
wherein when the icon is dragged, the display control unit displays the main area to be moved or reduced in size in a direction opposite to that of the drag, and sets an area generated outside the main area to be a virtual external area.

5. The display device according to claim 4,
wherein the display control unit divides the virtual external area into a plurality of areas and changes an operation in accordance with where in the virtual external area the icon is dropped.

6. The display device according to claim 4 or 5,
wherein the display control unit performs control so that if a plurality of icons are dropped in the first position, the icons are displayed one by one as moving outside the display area of the display device.

7. The display device according to claim 4,
wherein the display control unit reduces the icon in accordance with the dragging of the icon when the icon is larger than a predetermined value.

8. The display device according to claim 3,
wherein the display control unit performs a virtual frame display in which a frame portion of the display device is virtually displayed between the virtual external area and the main area.

9. The display device according to claim 8,
wherein the display control unit divides the virtual frame display into a plurality of areas, and changes an operation in accordance with which area from among the divided areas of the virtual frame display the icon passes through.

10. The display device according to claim 1,
wherein the display control unit displays the icon so that the icon moves to be moved from the first position to the second position like a piece of paper.

11. The display device according to claim 1,
wherein the display control unit considers a drag operation performed in another display device as a drag operation performed on an icon of the display device itself.

12. A display method comprising:
a display control step of displaying an icon so that the icon displayed on the display unit is moved from a first position to a second position,
wherein when a distance between the first position and the second position is shorter than a predetermined value, the icon is displayed so as to be moved from the first position to the second position via a detour.
